(19) United States
(12) Patent Application Publication
(10) Pub. No.: US 2023/0106299 A1
(43) Pub. Date: Apr. 6, 2023

(54) ANTI-BUCKLING DEVICE CAPABLE OF GUIDING A CYLINDRICAL ELEMENT THAT IS PUSHED AND MOVED OVER A GIVEN DISTANCE IN THE DIRECTION OF ITS AXIS

(71) Applicant: STERLAB, VALLAURIS (GR)

(72) Inventors: Thomas MAGNANI, Trouy (FR); Thomas MARIONI, Grasse (FR); Paul MARTEL, Saint-Raphaël (FR); Philippe POIGNET, Gignac (FR); Nabil ZEMITI, Montpellier (FR)

(21) Appl. No.: 17/910,751

(22) PCT Filed: Mar. 8, 2021
(86) PCT No.: PCT/FR2021/050389

§ 371 Date: Sep. 9, 2022

(30) Foreign Application Priority Data
Mar. 20, 2020 (FR) 2002744

(51) Int. Cl. E21B 19/24

(52) U.S. Cl. CPC E21B 19/24

(57) ABSTRACT

An anti-buckling device capable of guiding a cylindrical element that is pushed and moved over a given distance C in the direction of its axis XX′, said device being made up of at least two elementary cylindrical tubes that are nested and guided mutually in one another in order to form a tubular telescopic assembly of axis XX′ and of given length L, such that at least one of said elementary tubes comprises a transverse support having an orifice positioned inside the cylinder of the elementary tube capable of guiding said cylindrical element fitted into this orifice and pushed through this telescopic assembly.

The present invention relates to an anti-buckling device capable of guiding a cylindrical element that is pushed and moved over a given distance in the direction of its axis.

The technical sector of the invention is that of manufacturing a device for inserting a cylindrical element into an orifice into which the cylindrical element is slid and subjected to friction forces.

One of the main applications of the invention, but which is not limited thereto, relates to the medical field and more particularly to the use of a remote manipulator robot for inserting, into the body of a patient, a sheath or a fiber, generally semi-rigid, in a natural or artificial conduit with a high coefficient of friction, such as a vein or an artery for cardiac interventions, or the urethra, or an access sheath put in place beforehand, this semi-rigid fiber possibly being an optical fiber and this sheath possibly serving itself as a guide to insert thereafter therein, for example, an intervention tool.

Currently, the push to insert such a sheath or fiber is generally provided by two motorized rollers placed very close to the opening (either natural of the conduit, or performed surgically in this conduit) which avoids the problem of buckling of the sheath or of the fiber: admittedly this then progresses without problem but the placement, very close to the opening, of such motorized rollers is more complex than the implementation of a simple pushing system on the proximal end of the sheath or the fiber, thus at a distance from the opening, and may even prove to be impossible depending on the location concerned, in particular in the case of an intervention on a human body; moreover, there is a risk of buckling of the sheath or of the fiber when the latter is pulled back if it is not free at its proximal end.

In other fields such as oil drilling and/or exploration, where semi-rigid tubes or cables, pre-rolled on drums of a kind of winch, must also be inserted into wells drilled in the ground in order to lower sensors and/or measurement tools into same, said winches cannot be placed very close to the opening of the wells and are thus positioned at a certain height above it: taking then into account the risk of buckling of the tube or cable when the push on it is exerted too far from the opening (it is noted that the occurrence of buckling is a function of the square of the distance between the opening and the point of application of the pushing) it is known to arrange a cylindrical guide, of inner diameter similar to the outer diameter of the cable or measuring tube, to insert and slide the latter therein, between the opening of the well and the winch, which must push this tube or cable to overcome the frictional forces to which the latter is subjected inside the well, said guide then limiting the buckling of this tube under such operational loads since it can bear laterally against the inner wall of said cylindrical guide.

We can cite for example in this field patent application US 2008/0264626 by Mr. Bartley Patton of the company Schlumberger, which discloses a device that improves the possibility of injecting pre-coiled tubes which are uncoiled in order to be inserted into wells drilled in the ground by virtue of a guide, as explained previously, making it possible to support the pre-coiled tube which is uncoiled and pushed into this guide and then into the well: according to this US patent application, this guide consists of two parts which are nested and slide in one another in order to form a telescopic guide, which allows the connection of various well-control heads (located around and on the opening of these wells) to the injector (which is a kind of winch) of the pre-coiled tube that it uncoils, regardless of the height that separates them since the guide then adapts to it by making its two parts slide with respect to one another until reaching this height without thus requiring vertical movement of the pre-coiled tube injector; once adjusted to this correct height, the two parts of the guide are then fixed with respect to one another and no longer slide in operation.

However, it is true that if the height of the guide is high with respect to the diameter and rigidity of the cable or tube on the one hand and the pushing force of the winch on the other hand, the cable or tube may buckle in the guide, but this will limit its lateral movement, all the more so if it has an inner diameter fairly close to that of the external cable or tube, which is the case when the guide comprises only two parts sliding in one another as in the previously cited document.

In the remainder of this disclosure, the fibers, sheaths, cables, tubes, etc., which must be able to be inserted into any cylindrical “conduit” (natural or not) such as a well, a pipe, an artery, a vein, a urethra, etc. will be referred to by the generic term “cylindrical element”.

The problem posed is thus to be able to insert such a cylindrical element, and all the more so if it is semi-rigid without however being too flexible, into the opening of a conduit with a high coefficient of friction, by being pushed therein continuously at least by segment of given length and over a travel or distance of movement of the same length as the segment, by the proximal end of such consecutive segments, through a guide positioned between this opening and the proximal end of the segment in question of the cylindrical element, end to which the pushing is applied, and without risk of buckling of this segment of the cylindrical element inside this guide, regardless of the inner diameter and the length thereof.

### SUMMARY OF THE INVENTION

One solution to the stated problem is an anti-buckling device capable of guiding a cylindrical element, especially if it is semi-rigid, pushed and moved over a given travel or distance in the direction of its axis and consists of at least two elementary cylindrical tubes that are nested and guided mutually in one another in order to form a tubular telescopic assembly and of given length and such that according to the invention at least one of said elementary tubes, which slides into the adjacent elementary tube of larger diameter, comprises a transverse support having an orifice positioned inside, and in a particular embodiment at the center, of the cylinder of said elementary tube and capable of guiding said cylindrical element fitted into this orifice and pushed through this telescopic assembly.

In a preferred embodiment, the transverse support is positioned at the end of said at least one elementary tube, at the end by which it slides into the adjacent elementary tube of larger diameter.

In a preferred embodiment, the tubular telescopic assembly according to the invention retracts as and at the same time as the cylindrical element is pushed from the proximal end, where it is held together, toward the other distal end of this tubular telescopic assembly and the length thereof is equal, in the at least partially extended position, to the desired travel (for a segment of the same length of the cylindrical element which is thus pushed continuously) increased by the lengths of the distal and proximal ends of this telescopic assembly and of the length of the elementary tube of larger diameter.

According to different embodiments that are chosen according to operational needs, the tubular telescopic assembly can comprise either only two elementary tubes, or three as in the first embodiment depicted in the figures hereinafter, or more up to n tubes (like the eleven depicted in the second embodiment depicted in the figures hereinafter) knowing that the more elementary tubes there are, the more the inner and outer diameters of those which fit consecutively around the others will increase, and the last one has thus a considerable outer diameter.

In a preferred embodiment, all the elementary tubes comprise a transverse support having an orifice positioned inside, and in one particular embodiment at the center, of the cylinder of each elementary tube, and preferably this transverse support is in turn positioned at the end of each elementary tube which slides in the adjacent elementary tube of larger diameter.

The result is an anti-buckling device, capable of guiding a cylindrical element, especially if it is semi-rigid, that is pushed and moved over a given distance or travel in the direction of its axis, which addresses the stated problem since the at least one transverse support (or the transverse supports),
on the one hand, comprising an orifice positioned inside, and even at the center of the cylinder of each elementary tube and capable of guiding said cylindrical element fitted into this orifice,
on the other hand, being itself able to be positioned at the end of the elementary tube by which the latter slides in the adjacent elementary tube of larger diameter in order to form a tubular telescopic assembly, forms an internal guide that is close enough to the other guides (and all the more since the number of elementary tubes is large for a given travel) in the telescopic assembly that the cylindrical element, especially if it is semi-rigid, cannot buckle between two of these orifices forming guides when this cylindrical element progresses toward the distal end of the telescopic assembly (corresponding to the opening or orifice of the conduit with a high coefficient of friction into which said cylindrical element is to be inserted) even with a push from the proximal end, and there can be no buckling upon pulling back either, all the more so since the pulling is also performed from this proximal end.

Other problems then arise especially when the given travel, referred to as C, along which the cylindrical element is pushed (thus by segment of length equal to this travel C) is significant, that is to say for example 20 cm for a medical application, and a small length is required, referred to as D, of the telescopic assembly in the retracted position, for example 4 cm, the length, referred to as l, of each elementary tube will be small, such as of the order of 2 to 2.5 cm for the data above, and their number will be high, of the order of ten as in the second embodiment disclosed hereinafter: thus for a C/l ratio beyond five and particularly more than eight (as with the data above) and therefore a number of elementary tubes of more than six and even ten, problems of nesting and guiding the elementary tubes in one another, of risks of becoming detached from one another, of heeling, of the diameter of the outermost tubes becoming large, of lateral bending of the telescopic assembly and even of the risk of it buckling then arise.

These problems are also solved by specific characteristics, as disclosed hereinafter, of the present invention, the advantages of which are mentioned hereinbefore, and the solutions provided prove the interest thereof. The disclosure and the attached figures give two embodiments thereof, but other embodiments are possible within the scope of the present invention.

### BRIEF DESCRIPTION OF THE FIGURES

FIG. 1 is a side view of a first embodiment of a device according to the invention, made up of three elementary tubes, in the maximum extended position and wherein the references to the present disclosure are denoted with a “′”;

FIG. 2 is a longitudinal cross-sectional view, along a plane passing through its axis XX′, of the device of FIG. 1 still in the extended position;

FIG. 3 is a longitudinal cross-sectional view, like in FIG. 2, of the device of FIG. 1 but in the maximum retracted position.

FIG. 4 is a three-quarter side external perspective view of a second embodiment of a device according to the invention, made up of eleven elementary tubes, in the maximum retracted position and wherein the references to the disclosure hereinafter are noted without “′”;

FIG. 5 is a longitudinal cross-sectional view, along a plane passing through its axis XX′, of the device of FIG. 4 still in the maximum retracted position;

FIG. 6 is an external side view of the device of FIGS. 4 and 5 but in the maximum extended position;

FIG. 7 is a longitudinal cross-sectional view, like in FIG. 5, of the device of FIG. 6 in the maximum extended position;

FIG. 8 is a three-quarter side external perspective view of an elementary tube of a device according to the invention;

FIG. 9 is a three-quarter side external perspective view, partially cross-sectional (to better explain certain characteristics) over a quarter of their cylindrical part of three elementary tubes of a device according to the invention in the extended position;

FIGS. 10 to 12 depict a third embodiment of a device according to the invention, made up of a median tube of larger diameter receiving in each of its ends elementary tubes, respectively in a maximum extended position, in three-quarter side perspective, and on the one hand (FIG. 10) in external view and on the other hand (FIG. 11) partially cross-sectional over a quarter of its periphery, and a maximum retracted position in three-quarter side perspective and partially cross-sectional (FIG. 12) and wherein the references to the disclosure hereinafter are noted with “′”;

FIGS. 10 to 12 depict a third embodiment of a device according to the invention, made up of a median tube of larger diameter receiving in each of its ends elementary tubes, respectively in a maximum extended position, in three-quarter side perspective, and on the one hand (FIG. 10) in external view and on the other hand (FIG. 11) partially cross-sectional over a quarter of its periphery, and a maximum retracted position in three-quarter side perspective, and partially cross-sectional (FIG. 12) and wherein the references to the disclosure hereinafter are noted with “′”;

FIGS. 10 to 12 depict a third embodiment of a device according to the invention, made up of a median tube of larger diameter receiving in each of its ends elementary tubes, respectively in a maximum extended position, in three-quarter side perspective, and on the one hand (FIG. 10) in external view and on the other hand (FIG. 11) partially cross-sectional over a quarter of its periphery, and a maximum retracted position in three-quarter side perspective, and partially cross-sectional (FIG. 12) and wherein the references to the disclosure hereinafter are noted with “′”.

### DETAILED DESCRIPTION OF THE INVENTION

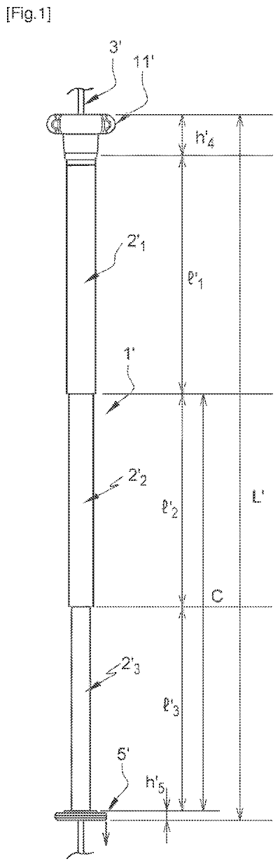

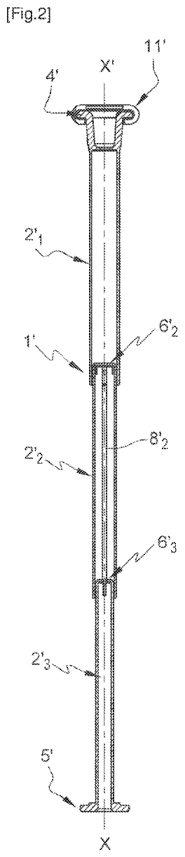

As depicted in the figures, the anti-buckling device, capable of guiding a cylindrical element 3 that is pushed and moved over a given travel C in the direction of its axis XX′, consists of at least two (or three in FIGS. 1 to 3, and eleven in FIGS. 4 to 7) elementary cylindrical tubes 2 that are nested in one another as tightly as possible while allowing them to slide with respect to each other without any effort, and thus guiding one another in order to form a tubular telescopic assembly 1 of axis XX′ and of given length L, which is capable of retracting as and at the same time as the cylindrical element 3 is pushed from the proximal end 4 toward the other distal end 5 of this tubular telescopic assembly 1.

The length L thereof is equal, in the at least partially extended position, to the travel C increased by the lengths h₄ and h₅ of the proximal and distal ends 4, 5 respectively of this telescopic assembly 1 and by the length l₁ of the elementary tube 2₁ of larger diameter as depicted in FIGS. 1, 2, 6 and 7 also in the maximum extended position.

According to the invention, at least one, and preferably all as depicted in the figures, of said elementary tubes 2ᵢ which slides inside the adjacent elementary tube of larger diameter 20 comprises a transverse support 6ᵢ comprising an orifice 7ᵢ positioned inside, and even at the center, of the cylinder of each elementary tube and capable of guiding said cylindrical element 3, in particular semi-rigid, fitted into this orifice 7ᵢ and pushed through this telescopic assembly 1.

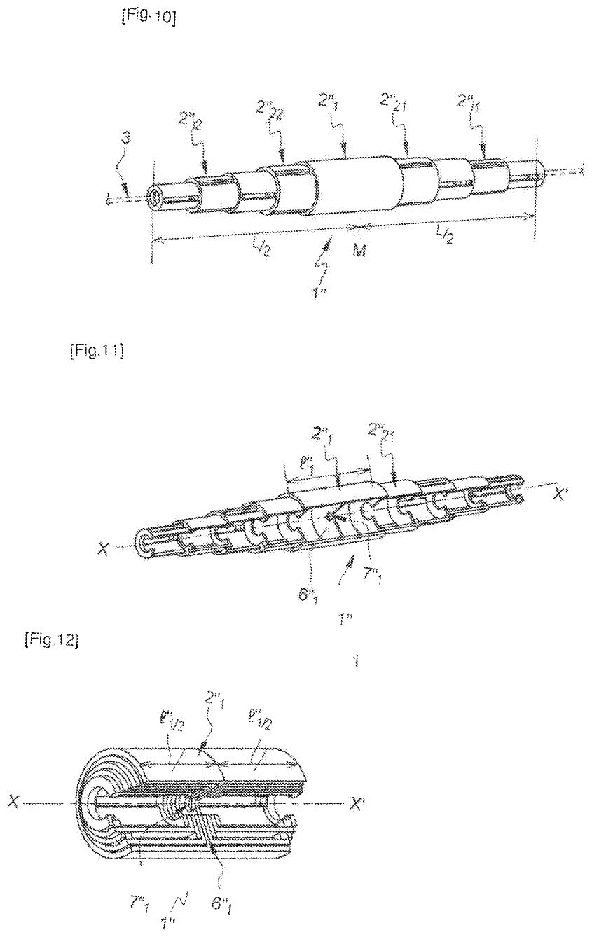

In the embodiments depicted in FIGS. 1 to 7 and 9, and in that depicted in FIGS. 10 to 12 with regard to the elementary tubes 2ᵢ other than the central tube 2₁″ of larger diameter, the transverse support 6ᵢ is positioned at the end of the elementary tube 2ᵢ, end by which it slides into the adjacent elementary tube of larger diameter 2ᵢ₋₁.

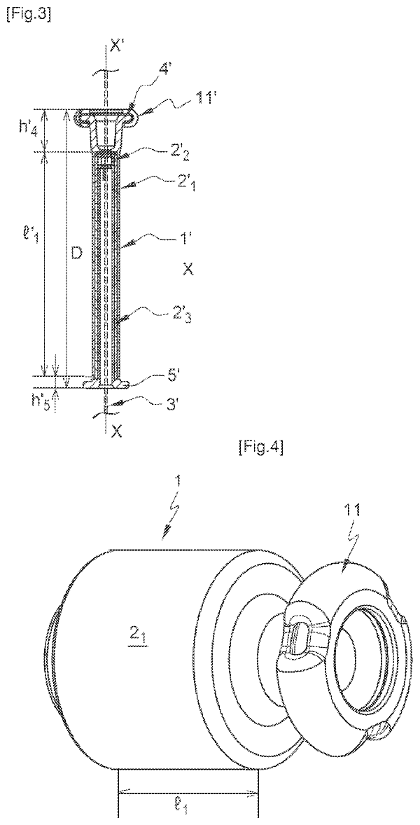

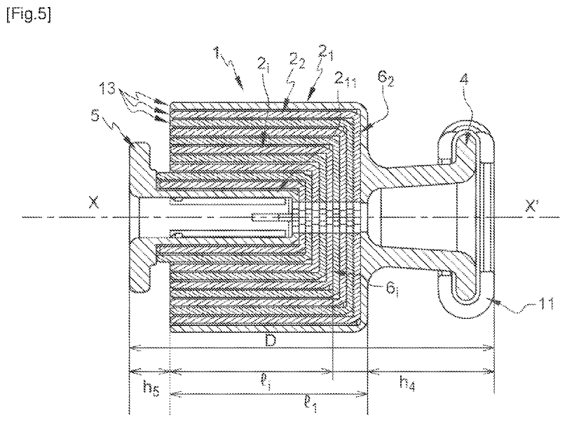

According to the embodiments depicted in FIGS. 1 to 7, the elementary tubes 2ᵢ are of decreasing length li (or equal, for a given elementary tube 2ᵢ, to the length lᵢ₋₁ of the adjacent elementary tube 2ᵢ₋₁ of larger diameter, in which the given elementary tube 2ᵢ, slides, reduced by at least the thickness of its transverse support 6ᵢ) from the elementary tube 2₁ of larger diameter, and either until the tube of smaller diameter like in FIG. 3, or until the third to last one like in FIG. 5, and so, as may be noted in these FIGS. 3 and 5, its minimum length D, in the totally retracted position, can be equal to the sum of that of the elementary tube 2₁ of larger diameter and those h₄ and h₅ of the ends 4, 5 of the telescopic assembly 1.

According to the embodiment depicted in FIGS. 10 to 12, the elementary tube 2₁″ of larger diameter is located at the middle M (in the direction of its axis XX′) of the telescopic assembly 1″ and comprises a transverse support 6₁″ of the orifice 7₁″ which is positioned about the axis XX′ on the inside, and even in one particular embodiment at the center, of the cylinder of this elementary tube 2₁″, said transverse support 6₁″ being in turn positioned near the middle, if not at the middle, of this elementary tube 2₁″ (in the direction of the length li″ thereof and thus splitting it into two): each end of length l₁″/2 of this elementary tube 2₁″ of larger diameter then receives at least one (such as four as depicted in these FIGS. 10 to 12) elementary cylindrical tube 2₂₁″ and 2₂₂″.

These elementary cylindrical tubes 2₂₁″ and 2₂₂″ have a length l₂″ at most equal to the half-length l₁″/2 of the elementary tube 2₁″ of larger diameter which receives them at each of its ends and are nested therein; then optionally other elementary tubes 2ᵢ₁″ and 2ᵢ₂″ (or three more according to FIGS. 10 to 12) consecutively nest inside one another, in order to form two opposing telescopic sub-assemblies, each of these sub-assemblies being able to be made like the telescopic assemblies 1 and 1′ disclosed previously according to FIGS. 1 to 9.

In this particular embodiment, the elementary tube 2₁″ of larger diameter is admittedly, for an identical total extension travel C and the same number of elementary tubes 2ᵢ, twice as long as in the embodiments according to FIGS. 4 to 7, which depicts a minimum retraction length that is also twice as long but then has a much smaller diameter, which can be useful and adequate according to the application in question.

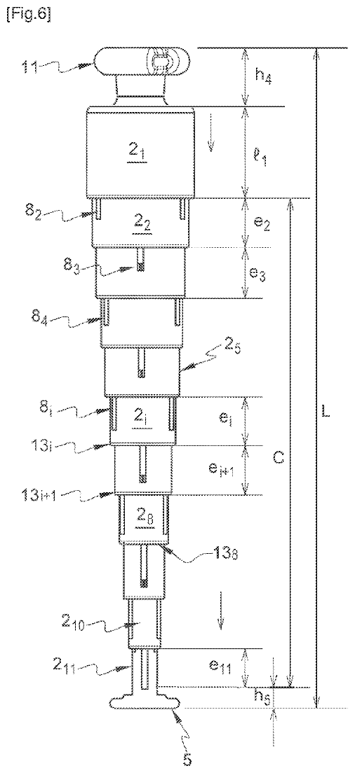

In order to further solve the aforementioned problems of nesting and guiding the elementary tubes 2 in one another, as well as of risks of these coming detached with respect to one another, each elementary tube 2ᵢ comprises on the one hand at least one notch as in the embodiment depicted in FIGS. 1 to 3 (or two and even three as depicted in FIGS. 6 to 9) forming a longitudinal slot 8ᵢ running partially along at least one generatrix of this elementary tube 2ᵢ and on the other hand at least one lug 10ᵢ (or two and even three as depicted also in FIGS. 6 to 9) positioned on its cylindrical wall 12ᵢ and capable of being inserted into and engaging with the at least one longitudinal slot 8 of an adjacent elementary tube 2.

In the case of several slots 8ᵢ, these preferentially split uniformly, at the same distance from one another, the periphery of the elementary tube 2i, and in this case there are also several lugs 10ᵢ (or as many as there are slots) which are positioned at the same distance from one another on the cylindrical wall of the elementary tube 2i.

Thus, according to the location and the length of the one or more longitudinal slots 8ᵢ for each elementary tube 2ᵢ and the position of the one or more lugs 10ᵢ on the adjacent elementary tube, the travel eᵢ of each of the elementary tubes 2ᵢ is limited both in the direction of their extension with respect to the tube into which it is nested (while ensuring that the sum of all these elementary travels eᵢ is at least equal to the total desired travel C for extension of the telescopic assembly 1) and in the direction of their retraction, and this thus guarantees nesting and overlapping (between the cylindrical walls of two adjacent elementary tubes 2i, 2i−1 and 2i, 2i+1) which are sufficient in the maximum extended position to allow correct guiding and maintaining of these elementary tubes in the axis XX′, and thus the risk of the telescopic assembly 1 becoming detached is entirely avoided.

To also solve the problems of heeling of the elementary tubes 2i, of lateral bending of the telescopic assembly 1 in the maximum extended position, and even of the risk of it buckling thereof, the length li of each elementary tube 2i can be determined in such a way that the overlap, in the totally retracted position, of each elementary tube 2i+1 by the next one 2i is maximum, as it appears for example in FIG. 5, the length li of each elementary tube 2i+1 not exceeding that of the adjacent tube 2i in which it is nested. The heeling of the elementary tubes 2i against one another is thus reduced as is the lateral bending and the risk of buckling of the telescopic assembly 1.

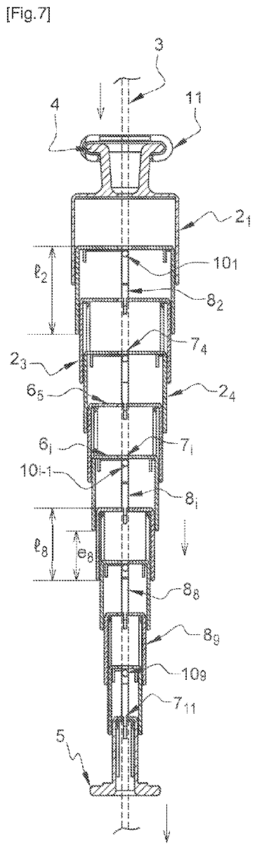

Thus, for example, as depicted in FIG. 7, the travel ei of the elementary tubes 2i having small diameters (located toward the distal end 5 of the telescopic assembly 1) can be 80% of the height li of their cylindrical wall 12i while the travel of those having large diameters (located toward the proximal end 4 of the telescopic assembly 1) can be 60%.

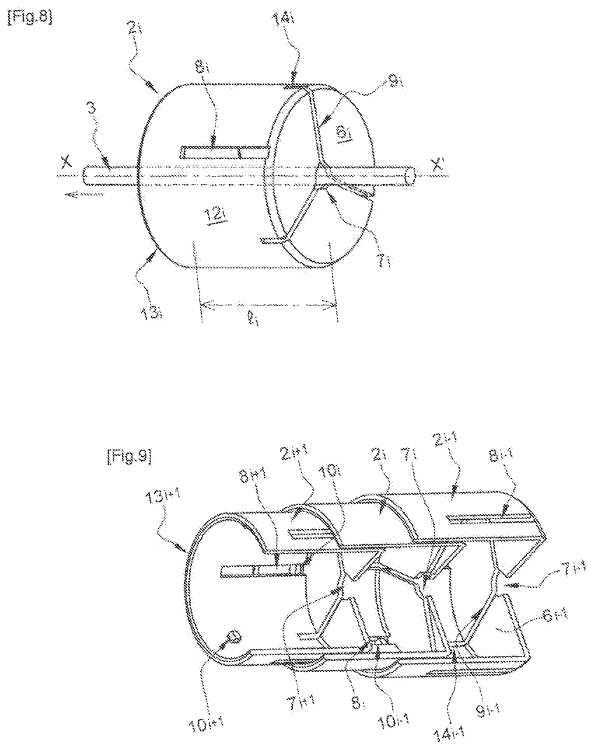

In a preferred embodiment the support 6ᵢ of each elementary tube 2ᵢ (which could also be for example a simple crosspiece positioned along a radius of the cylinder of the elementary tube and extending from its wall 12ᵢ, where it is fixed, to the inside, and even in one particular embodiment at the center, of the cylinder, or a sort of perforated mesh covering all or part of the section of the cylinder) is a bulkhead forming a sheet-disc bored by said orifice 7ᵢ and comprising at least one (or two and even three in the embodiment depicted in FIGS. 8 and 9) radial notch forming a slot 9ᵢ from the cylindrical wall 12ᵢ of the elementary tube 2ᵢ, into which one of its ends 14ᵢ opens, to said orifice 7ᵢ into which its other end opens; and when there are several slots, these uniformly split, into as many zones of the same area (or for three slots 9ᵢ, disc quarters with a 120° angle at the center) the surface of the sheet-disc 6ᵢ: these radial slots 9ᵢ make it possible to deform the wall 12ᵢ of each elementary tube 2ᵢ in order to allow the passage and the insertion of its lug or lugs 10ᵢ into the longitudinal notch or notches 8ᵢ of the adjacent elementary tube and thus to facilitate the nesting of the tubes in one another during the mounting and assembly of the telescopic assembly 1.

Preferably, as it can be seen in FIG. 9, the at least one (as depicted in FIGS. 1 to 3, or two, or three as depicted in the embodiment according to FIGS. 4 to 7, or even more) lug 10ᵢ is positioned on the inner surface of the cylindrical wall 12ᵢ of each elementary tube 2ᵢ, along a generatrix thereof extending the end 14ᵢ of the at least one radial notch 9ᵢ opening onto said wall 12ᵢ and toward the edge 13ᵢ thereof opposite to the support 6ᵢ, said lug being inserted into the longitudinal slot 8ᵢ₊₁ of the adjacent elementary tube 2ᵢ₊₁ of smaller diameter which slides inside said elementary tube 2ᵢ.

The at least one (or two or more) longitudinal notch 8ᵢ and the at least one (or two or more) radial notch 9ᵢ of each elementary tube 2ᵢ are positioned staggered with respect to one another and at an equal distance from one another, thus forming:
in the case of a single longitudinal notch and a single radial notch, as in FIGS. 1 to 3, two angles of 180° therebetween since they are then diametrically opposite one another,
in the case of three longitudinal notches 8ᵢ and three radial notches 9ᵢ, as according to FIGS. 4 to 7, angles of 60° therebetween.

The telescopic assembly 1 can also comprise a rotating system 11 at least at one of its ends 4, 5 (or in FIGS. 1 to 7, at the proximal end 4 at which the pushing on the cylindrical element 3 is also exerted) and which is capable of allowing the rotation of this telescopic assembly 1.

1. An anti-buckling device capable of guiding a cylindrical element, that is pushed and moved over a given travel C in the direction of its axis XX′ and consists of at least two elementary cylindrical tubes that are nested and guided mutually in one another in order to form a tubular telescopic assembly of axis XX′ and of given length L, wherein at least one of said elementary tubes comprises a transverse support having an orifice positioned inside the cylinder of the elementary tube and capable of guiding said cylindrical element fitted into this orifice and pushed through this telescopic assembly.

2. The anti-buckling device according to claim 1, wherein the transverse support is positioned at the end of the elementary tube, end by which it slides into the adjacent elementary tube of larger diameter.

3. The anti-buckling device according to claim 1, wherein the tubular telescopic assembly retracts as and at the same time as the cylindrical element is pushed from the proximal end toward the other distal end of this tubular telescopic assembly.

4. The anti-buckling device according to claim 3 wherein the overlapping of at least one elementary tube by another is total in the totally retracted position.

5. The anti-buckling device according to claim 3, wherein each elementary tube comprises on the one hand at least one notch forming a longitudinal slot running partially along at least one generatrix of this elementary tube, and on the other hand at least one lug positioned on its cylindrical wall and which is inserted into the longitudinal slot of an adjacent elementary tube.

6. The anti-buckling device according to the claim 1 wherein the transverse support having the orifice is positioned at the center of the cylinder of the elementary tube, which comprises said support.

7. The anti-buckling device according to the claim 1, wherein the support of each elementary tube is a bulkhead forming a sheet-disc bored by said orifice.

8. The anti-buckling device according to claim 7, wherein the sheet-disc comprises at least one radial notch forming a slot from the cylindrical wall of the elementary tube into which one of its ends opens to said orifice into which its other end opens.

9. The anti-buckling device according to claim 5, wherein the at least one lug is positioned on the inner surface of the cylindrical wall of each elementary tube, following at least one generatrix thereof extending the end of the at least one radial notch opening onto said wall and toward the edge thereof opposite to the transverse support, said lug being inserted into the at least one longitudinal slot of the adjacent elementary tube of smaller diameter which slides inside said elementary tube.

10. The anti-buckling device according to claim 5, wherein the at least one longitudinal notch and the at least one radial notch are positioned staggered with respect to one another.

11. The anti-buckling device according to the claim 1, wherein it comprises a rotating system at least at one of the ends of the telescopic tubular assembly capable of allowing the rotation of this telescopic assembly.
